(19) United States
(12) Patent Application Publication
(10) Pub. No.: US 2004/0246701 A1
(43) Pub. Date: Dec. 9, 2004

(54) Light and rotary structure outside of crystal ball

(76) Inventor: Jack Liu, Hsin-Chu (TW)

Correspondence Address: DENNISON, SCHULTZ, DOUGHERTY & MACDONALD, 1727 KING STREET, SUITE 105, ALEXANDRIA, VA, 22314, US

(21) Appl. No.: 10/455,343

(22) Filed: Jun. 6, 2003

(51) Int. Cl. F21V 21/30; F21V 3/00

(52) U.S. Cl. 362/35; 362/285; 362/363; 362/806

(57) ABSTRACT

The invention is a light and rotary structure outside of crystal ball, that is light device passes through crystal ball having opening on the top and the rubber plug of the lower part, the light device can provide the interior of crystal ball with light, in addition, can selectively provide model out of the ball with change of static or rotary and model in the ball with change of static or rotary cooperating sight design to improve the decorativeness and interest of the crystal ball.

### FIELD OF INVENTION

This invention relates to a light and rotary structure outside of crystal ball, that's light device is put on the top of crystal ball to lighten the inertia of crystal ball, with the rotate movement and cooperate the static or rotary model in the crystal ball the invention can display splendid sight by the refraction and diffusion that water to light can improve the decorativeness and interest of the crystal ball.

### BACKGROUND OF INVENTION

The typical decorative crystal ball, static or dynamic model such as trees, castle or picture are set in the inertia of crystal ball, with a music bell group on the manual spring on the base of crystal that make the crystal ball have sight decorate and melodious music double effect. Further, adding light on the base of crystal ball to make subject model ornament have the triple effect: dynamic sight, music and light.

Above mentioned dynamic ornament mostly set the illuminant under the sight model, because of the liquid in the transparent ball will expanse when be heated and contract when be cooled with the climate change so sight model will sink when liquid solidify when be cooled. To absorb the sink that caused from said phenomena of expanse when be heated and contract when be cooled, there is a gap at lest 5 mm left between the illuminant and sight model. However, the lightness of cast light will be dim because of the preset gap and that will influence the lightness of exterior, and will discount the entire lightness, and further discount the effect lightness change of entire dynamic sight.

Because the most variability aspect of crystal ball resists in the interesting and decorative effect, so the crystal ball manufacture think over to improve the aesthetic feeling to absorb the consumers.

The inventor has the manufacture experience on crystal ball and with the attitude that keep improving and achieve the “light and rotary structure outside of crystal ball” by experiment and design.

### SUMMARY OF INVENTION

The main object of the present invention is to provide a light and rotary structure outside of crystal ball, that is light device is set on the top of crystal ball to light the interior of the crystal ball, make the static or rotary model in the ball display shiny sight by the refraction and diffusion that water to light.

Another object of the present invention is to provide a light and rotary structure outside of crystal ball that is light device is set on the top of crystal ball to rotate the model out of ball by traditional power to improve the dynamic sight of crystal ball.

The another object of the present invention is to provide a light and rotary structure outside of crystal ball, to rotate the model in the ball by traditional power to improve the dynamic sight of crystal ball.

To achieve the mentioned object, the present invention provide a light and rotary structure outside of crystal ball, that is light device pass through the crystal ball having open on the top and the rubber plug of the lower part, the light device can provide the interior of crystal ball with light, in addition, can selectively provide model out of the ball with change of static or rotary and model in the ball with change of static or rotary cooperating sight design to improve the decorativeness and interest of the crystal ball.

### BRIEF DESCRIPTION OF DRAWINGS

FIG. 1 is a sectional view of the first embodiment of the present invention.

FIG. 2 is an enlarge view of part A in FIG. 1.

FIG. 3 is an enlarge view of part B in FIG. 1

FIG. 4 is a sectional view of the second embodiment of the present invention.

FIG. 5 is an enlarge view of part C in FIG. 4.

### DETAILED DESCRIPTIONS OF EMBODIMENTS

The present invention will now be described in further detail hereinafter, with reference to the accompanying drawings.

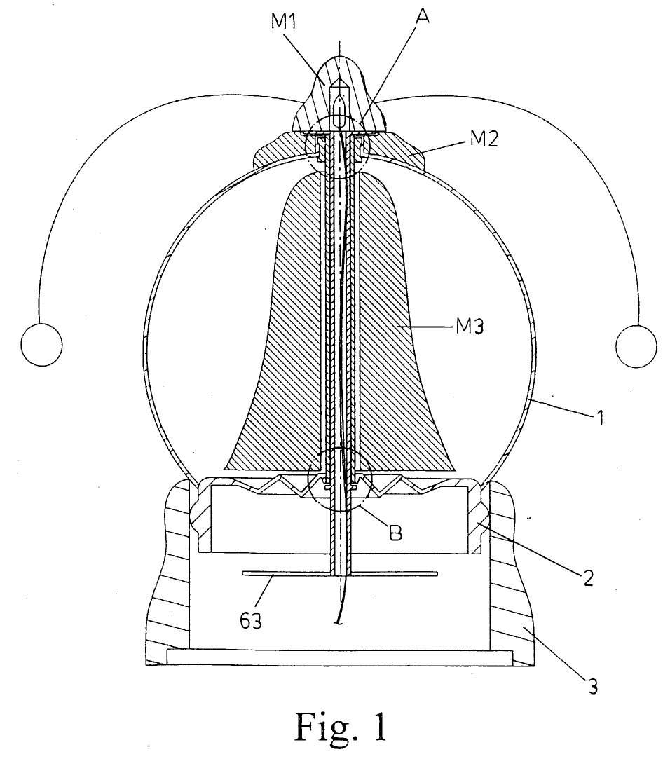

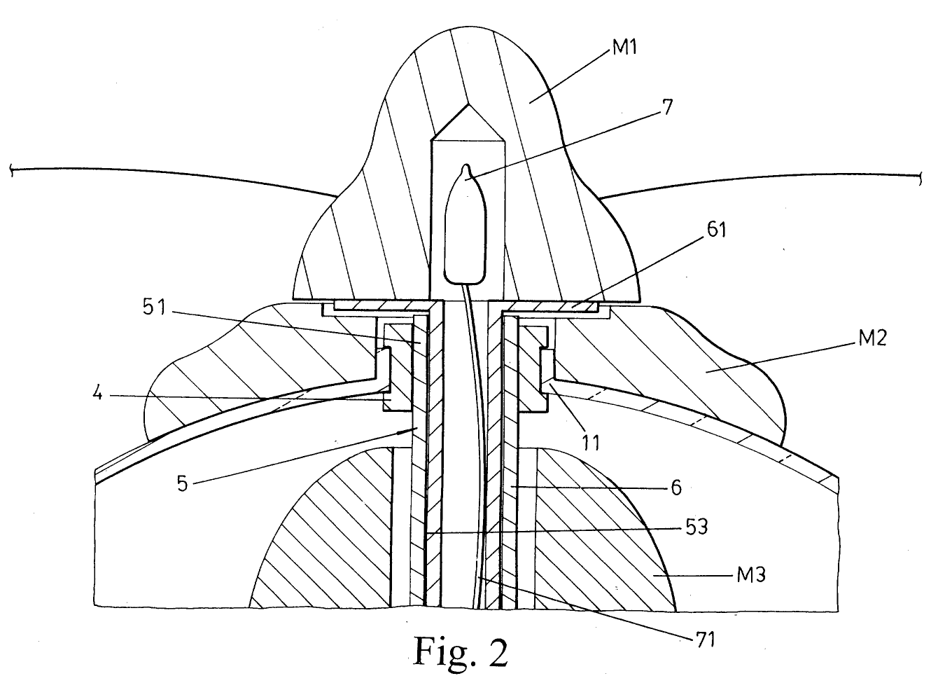

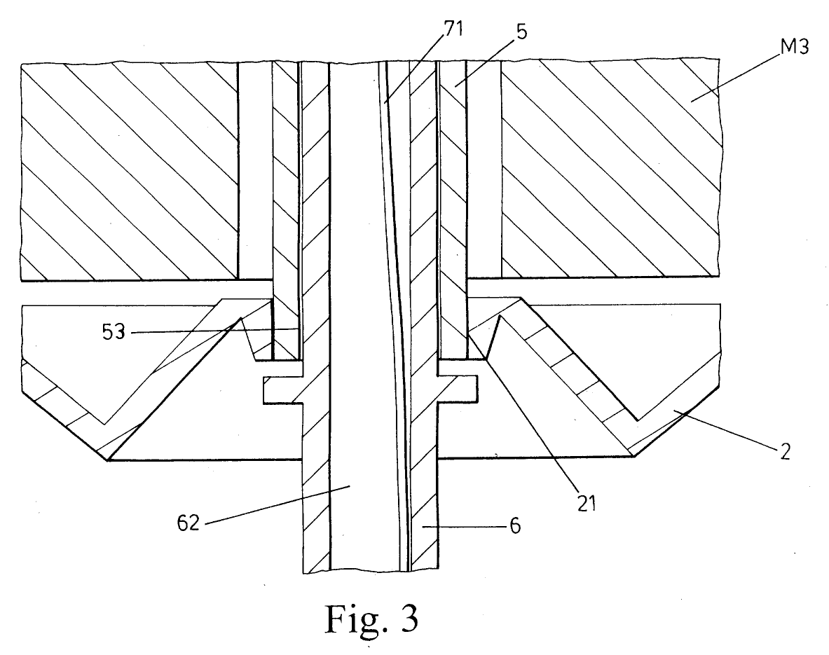

Now refers to FIG. 1 to FIG. 3, the view of the first embodiment of the invention is illustrated, wherein, the lower part of crystal ball 1 having opening on the top and rubber plug 2 and base 3 are sealed together, the opening 11 on the top of crystal ball 1 is sealed with hollow annular plug 4, the hollow annular plug 4 is sealed with a transparent or opaque sleeve 5, the sleeve 5 stand longitudinal in the interior of the crystal ball 1, the upper part 51 of the sleeve 5 is sealed with said hollow annular plug 4, the lower part 52 of the sleeve 5 is fixed on the central opening 21 of said rubber plug 2 to seal completely the liquid in the crystal ball 1 and prevent the liquid from leaking, a transparent or opaque drive tube 6 disposed through the hollow channel 53 formed in sleeve, the top planar disc 61 of drive tube 6 sticks the semi-transparent or opaque model out of ball, the appearing part between plannar disc 61 and the top 11 of crystal ball 1 can stick decorative model M2 to realize hiding or beauty effect.

Bulb 7 and power wire 71 thereof pass through opening 62 of the lower part of drive 6 and be disposed in the hollow groove of model M1 out of ball, the foot 63 on the lower part of drive 6 receives the power released from mechanical energy that accumulated on the manual spring of traditional power such as motor or music bell (not shown) to rotate the model M1 out of ball on the top 61 of drive tube 6. When bulb 7 is lighten, the light will pass through model M1 out of the ball and cast from the top down to model M3 in the crystal ball, and make the model M3 in the ball more splendid and improve the design object of decorate and interesting by the refraction that liquid in the crystal ball to light and the enlarge effect of convex of crystal spherical glass.

The second embodiment of the invention omits the traditional power, that is only provide light and keep the model out of the ball static, and the drive tube is omit in the embodiment, and the bulb 7 and power wire 71 there of pass through the lower part 52 of hollow channel 53 of said sleeve 5 and be disposed in the hollow groove of the model M1 out of ball. And model M1 out of ball be stuck directly on the outer perimeter of opening 11 on the top of crystal ball 1, and so that can keep model M1 out of ball static, and the light from bulb 7 only cast to model M3 in the crystal ball form the top down.

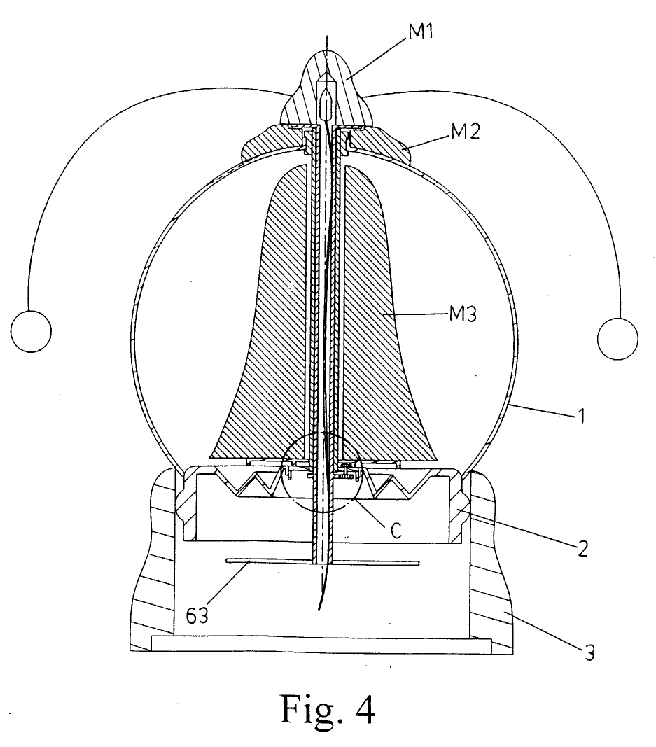

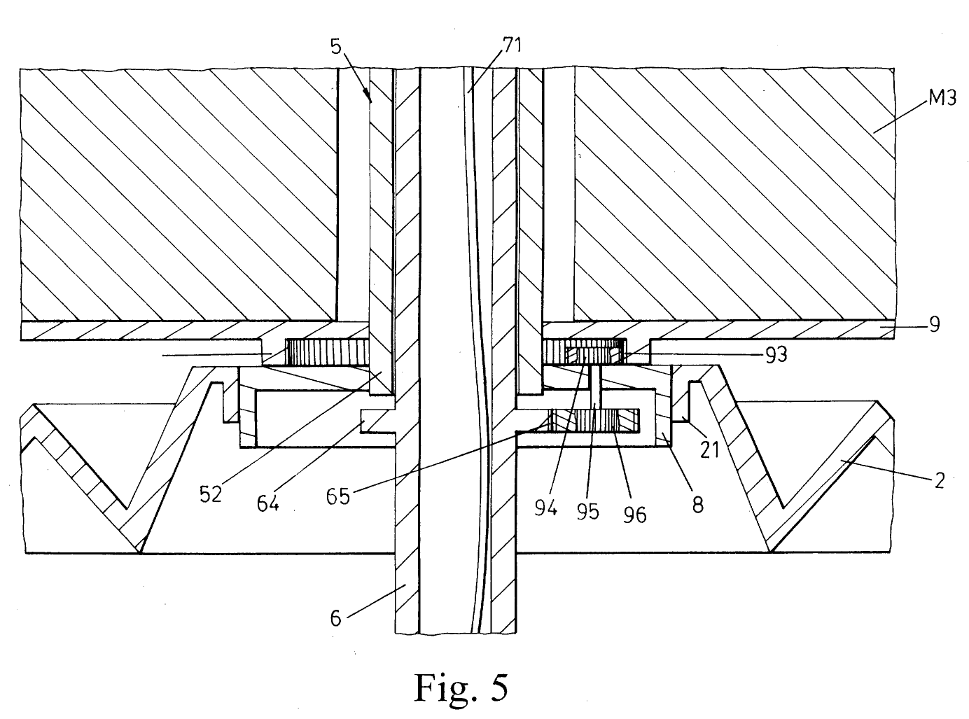

Please refers to FIG. 4 and FIG. 5, the third embodiment of the present invention is illustrated, the central opening 21 of rubber plug 2 seals with a loading disc 8, the center of the loading disc 8 seals with the bottom 52 of sleeve 5, the top planar 91 of the model turntable 9 carried upon the loading disc 8 sticks model M3 in the ball, the inner edge of the annular part 92 protruding down from bottom of model turntable 9 defines driven gear 93, the driven gear 93 meshes with upper gear 94 in the drive gear cluster, the apostle 95 of the driver gear cluster pass through the loading disc 8 and enable lower gear 96 meshes with drive gear 65 protruding disposed on the outer edge 64 on the lower part of the drive tube 6, when foot 63 of lower part of drive 6 receives the power released from mechanical energy that accumulated on the manual spring of traditional power such as motor or music bell (not shown) to rotate the model M1 out of ball on the top 61 of drive tube 6, and on the same time the drive gear 65 protruding disposed on the outer edge 64 of lower part of drive 6 will rotate the driven gear 93 and model turntable 9 thereof together by drive gear cluster, and the rotate dynamically the model M1 out of ball on the top of crystal ball and model M3 in the crystal ball. When bulb 7 is lighten, the light will pass through model M1 out of the ball and cast from the top down to model M3 in the crystal ball, and make the model M3 in the ball more splendid and improve the design object of decorativeness and interesting by the refraction that liquid in the crystal ball to light and the enlarge effect of convex of crystal spherical glass.

In summary, the design of the invention is simple and novel, that is light device passes through crystal ball having opening on the top and the rubber plug of the lower part, the light device can provide the interior of crystal ball with light, in addition, can selectively provide model out of the ball with change of static or rotary and model in the ball with change of static or rotary cooperating sight design to improve the decorativeness and interest of the crystal ball.

What is claimed is:

1. An light and rotary structure outside of crystal ball, the lower part of crystal ball having opening on the top and rubber plug and base being sealed together, wherein the opening on the crystal ball top sealing with hollow annular plug, the hollow annular then sealing with sleeve, the upper part of the sleeve sealing with said hollow annular plug, lower part of the sleeve being fixed on the central opening of said rubber seal, drive tube passing through the hollow channel disposed in the sleeve, the top planar disc of the drive tube sticking model out of the ball.

2. The light and rotary structure outside of crystal ball according to claim 1, wherein sleeve and drive tube are transparent or opaque tubular objects.

3. The light and rotary structure outside of crystal ball according to claim 1, wherein the model out of the ball is semitransparent or opaque ornament.

4. The light and rotary structure outside of crystal ball according to claim 1, wherein the hollow channel of the drive tube is for bulb and power wire passing through form the opening of the lower part.

5. The light and rotary structure outside of crystal ball according to claim 1, wherein foot on the bottom of drive tube receive traditional power to drive model out of the ball on the top of crystal ball rotate.

6. The light and rotary structure outside of crystal ball according to claim 5, wherein traditional power is motor or music bell.

7. A light and rotary structure outside of crystal ball, the lower part of crystal ball having opening on the top and rubber plug and base are sealed together, wherein the opening on the crystal ball top seals with hollow annular plug, the hollow annular then seals with sleeve, the upper part of the sleeve seals with said hollow annular plug, lower part of the sleeve is fixed on the central opening of said rubber seal, bulb and power wire passes through the hollow channel disposed in the sleeve, the outer per miter edge on the top of crystal ball sticks the model out of the ball.

8. The light and rotary structure outside of crystal ball according to claim 7, wherein sleeve is transparent or opaque tubular object.

9. The light and rotary structure outside of crystal ball according to claim 7, wherein model out of the model is semitransparent or opaque ornament.

10. The light and rotary structure outside of crystal ball according to claim 7, wherein the hollow channel of the sleeve is for bulb and power wire thereof passing through form the opening of the lower part.

11. A light and rotary structure outside of crystal ball, the lower part of crystal ball having opening on the top and rubber plug and base are sealed together, wherein the opening on the crystal ball top seals with hollow annular seal, the hollow annular then seals with sleeve, drive tube passes through hollow channel defined in the sleeve, the top planar disc of drive tube sticks the model out of the ball.

12. The light and rotary structure outside of crystal ball according to claim 11, wherein sleeve and drive tube are transparent or opaque tubular objects.

13. The light and rotary structure outside of crystal ball according to claim 11, wherein model out of the ball is semitransparent or opaque ornament.

14. The light and rotary structure outside of crystal ball according to claim 11, wherein the central opening of the rubber seal seals with loading disc, the center of the loading disc seals with bottom of the sleeve, the top planar of model turntable carried on the upper of loading disc sticks a model in the ball, the inner edge of the annular part protruding down from bottom of model disc defines driven gear, the driven gear meshes with the upper gear in the drive gear cluster, after the apostle of drive gear cluster passing through the loading disc then enable lower gear meshes with the drive gear protruding disposed on outer edge of lower part of drive tube.

15. The light and rotary structure outside of crystal ball according to claim 11, wherein the hollow channel of the drive tube is for bulb and power wire passing through form the opening of lower part.

16. The light and rotary structure outside of crystal ball according to claim 11, wherein foot disposed on the bottom of drive tube receives traditional power to drive model out of the ball on the top of crystal ball rotate, the drive gear protruding disposed on the outer edge of lower part of drive tube rotate the driven gear and the model turntable together by transmit gear.

17. The light and rotary structure outside of crystal ball according to claim 16, wherein traditional power is motor or music bell.
